(19) United States
(12) Patent Application Publication
(10) Pub. No.: US 2002/0001096 A1
(43) Pub. Date: Jan. 3, 2002

(54) Image processor for detecting specified pattern

(76) Inventors: Kenro Hama, Amagasaki-Shi (JP); Akira Murakawa, Osaka (JP); Keisuke Hashimoto, Kyoto-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/843,703

(22) Filed: Apr. 30, 2001

(30) Foreign Application Priority Data
Apr. 28, 2000 (JP) 2000-129762
Apr. 28, 2000 (JP) 2000-129763

(51) Int. Cl. G06F 15/00

(52) U.S. Cl. 358/1.9; 358/1.18

(57) ABSTRACT

In an image processor, it is decided that a target pixel has a specified color when the input color data of the pixel are decided to exist in the first ranges and the differences between color data of the pixel and those of pixels adjacent thereto are decided to exist in the second ranges. Thus, the specified color in a specified pattern can be detected even when the input image data are affected by external factors. Alternatively, it is decided that the pixel has a specified color when the input color data of the pixel are decided to exist in the first ranges and the results of calculation on the input color data are decided to exist in the second ranges. Errors in color detection can be decreased by narrowing the color detection ranges with use of different types of conditions.

This application is based on applications Nos. 2000-129762 and 2000-129763 filed in Japan, the contents of which are hereby incorporated by reference.

### BACKGROUND OF THE INVENTION

1. Field of the Invention

The present invention relates to image processing for detecting a specified pattern in an image.

2. Description of Prior Art

Recently, a color copying machine provides many functions with improved performance, and counterfeit on paper money, securities or the like becomes a big problem. Then, effective countermeasures for preventing counterfeit have been researched. In one of the countermeasures, specified patterns have been embedded in a design in a paper money or the like. When an image scanned is read in copying operation in a copying machine, the scanned image is analyzed, and when a specified pattern is detected in the image, normal image forming is forbidden.

When a paper money or the like is scanned, it has to be detected from the scanned image even when the paper money or the like is put in an arbitrary position on the scanner or even when it has stains, damages or the like locally.

Most of the input data received from an input device such as a scanner are color image having many data. Further, there is a tendency that the input and output devices can deal an image at higher speed and at higher resolution. However, real time image processing or detection of specified patterns is required in order to prevent counterfeit. Then, it is an important problem to develop a technique of image detection at high speed even in the presence of noises.

When an image is read with a scanner, the color of the read image is changed with scan conditions. Further, input image data are affected by deterioration of the scanner, change in environmental conditions, change in stress conditions or the like. Therefore, in order to detect a specified image, it is needed to widen the range of color of the specified image to be detected. On the other hand, the widening of color range is a factor which increases noises and detection errors.

### SUMMARY OF THE INVENTION

An object of the present invention is to perform image processing for detecting a specified color at a higher precision.

In one aspect of the invention, in an image processor, a first decision controller decides whether input color data of a target pixel exist in first ranges, and a second decision controller decides whether differences between color data of the target pixel and those of pixels adjacent thereto exist in second ranges different from the first ranges. Then, a color decision controller decides that the target pixel has a specified color when the color data of the pixel are decided to exist in the first ranges and the differences are decided to exist in the second ranges.

In another aspect of the invention, in an image processor, a first decision controller decides whether input color data of a target pixel exist in first ranges, and a second decision controller performs calculation on the input color data of the target pixel and decides whether results of the calculation exist in second ranges different from the first ranges. Then, a color decision controller decides that the target pixel has a specified color when the color data of the pixel are decided to exist in the first ranges and the differences are decided to exist in the second ranges.

An advantage of the present invention is that a specified color in a specified pattern can be detected even when the input image data are affected by external factors.

Another advantage of the present invention is that errors in color detection can be decreased by narrowing the color detection ranges with use of different types of conditions.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is a diagram of an image processor according to a first embodiment of the invention;

FIG. 2 is a schematic block diagram of a part of the image processor including a controller thereof;

FIG. 3 is a flowchart of detection of a specified pattern in a first embodiment of the invention;

FIG. 4 is a flowchart of detection of a specified color;

FIG. 5 is a flowchart of first decision;

FIG. 6 is a flowchart of second decision;

FIG. 7 is a diagram for illustrating an example of color decision;

FIG. 8 is a flowchart of second decision according to a second embodiment of the invention;

FIG. 9 is a diagram for illustrating an example of color decision in R and G space; and

FIG. 10 is a diagram for illustrating another example of color decision in R and G space.

### DETAILED DESCRIPTION OF THE PREFERRED EMBODIMENTS

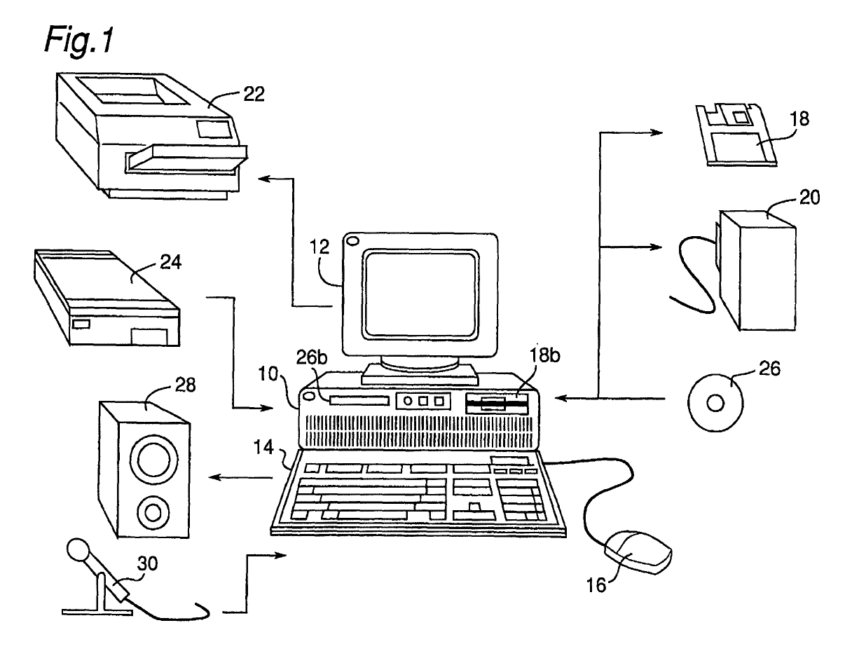

Referring now to the drawings, wherein like reference characters designate like or corresponding parts throughout the several views, FIG. 1 shows an image processor (hereinafter referred to as system) according to a first embodiment of the invention schematically. The system has a controller 10 which has a central processing unit (hereinafter referred to as CPU) to control the entire system. The controller 10 has a display device 12 for displaying images, characters or the like, and a keyboard 14 and a mouse 16 provided for inputting data and instructions. A flexible disk 18, a hard disk (not shown) and a CD-ROM 26 are used as recording media, and a flexible disk drive 18b, a CD-ROM drive 26b and a hard disk drive 20 are provided therefor. Further, the controller 10 is connected to a printer 22 for printing text data, an image or the like, a scanner 24 for acquiring image data, a speaker 28 for generating sound, and a microphone 30 for receiving sound.

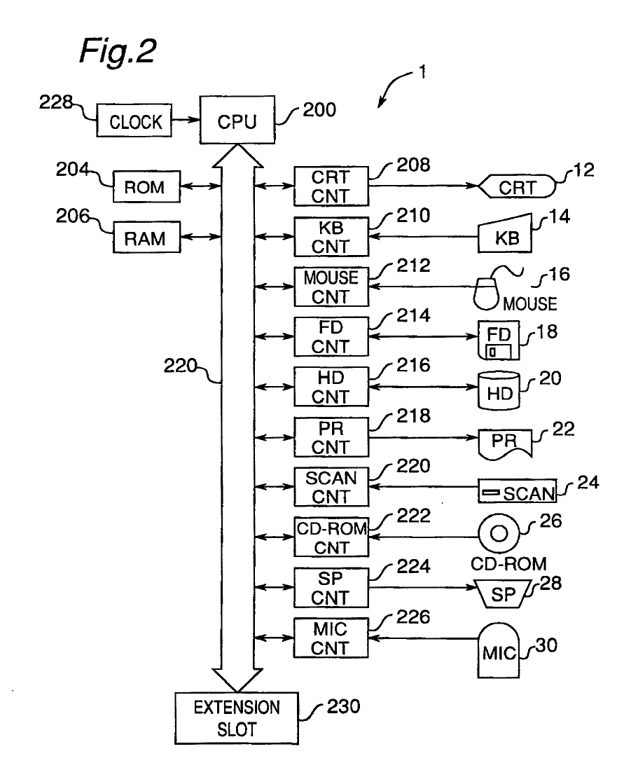

FIG. 2 shows a structure of the controller 10. The CPU 200 is connected via a data bus 202 to a read only memory (ROM) 204 for storing a program to control the system or the like, and to a random access memory 206 for storing the program or the like temporarily used by the CPU 200. Further, CPU 200 is connected via the data bus 202 to a display controller 208 for displaying images or characters in the display device 12, to a keyboard controller 210 for transmitting key-inputs from the keyboard 14, to a mouse controller 212 for transmitting input signal from the mouse 16, to a flexible disk drive controller 214 for accessing the flexible disk drive 18b, to a hard disk drive controller 216 for accessing the hard disk drive 20, to a printer controller 218 for controlling the printer 22, to a scanner controller 220 for controlling the scanner 24, to a CD-ROM controller 222 for controlling the CD-ROM drive 26b, to a speaker controller 224 for controlling the speaker 28 and to a microphone controller 226 for controlling the microphone 30. Further, the CPU 200 is connected to a clock circuit 228 for generating reference clock signals for operating the system, and it has an extension slot 230 for connecting an extension board.

In this system, a program for image processing is stored in a recording medium such as the ROM 204. However, the program or a part thereof may be stored in a recording medium such as a flexible disk 18, a hard disk 20 or a CDROM 26. When necessary, it is read therefrom and written to the RAM 206. A magneto-optical disk or the like may also be used as a storage medium. The scanner 24 is used as a device for inputting image data, but a different data input device such as a still video camera or a digital camera may also be used. Further, by connecting a network board to the extension slot 230, a program or an image data may be received through a network.

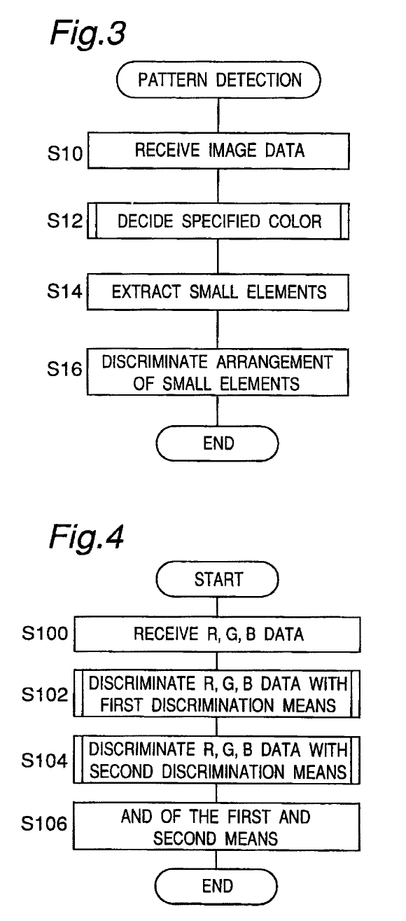

The image processor decides whether the input image includes a specified pattern having a plurality of small elements arranged to have a predetermined position relationship between them. FIG. 3 shows a flowchart of the detection of the specified pattern. First, image data having a plurality of color data for each pixel is received from an image input device such as a scanner (S10). Next, it is decided whether pixels in the input image data have the specified color (S12). Then, based on the result of color decision, small elements having the predetermined pattern are extracted, and a center thereof is determined (S14). Finally, it is discriminated whether a center of the small elements is arranged at a specified position (S16) Thus, the specified pattern is detected in the input image.

When the scanner 24 reads an image, the color of the read image is affected with scan conditions. Similarly, an image may vary with environment conditions or stress conditions. Therefore, in order to detect a specified image, it is necessary to widen the detection range of colors by a color decision means. However, the widening of the decision range is liable to increase noise components and to generate detection errors. Then, in order to widen the detection range of colors without increasing detection errors, it is checked not only whether the gradation values of R, G, B of a pixel exist in predetermined first ranges to define the specified color, but it is also checked whether differences of the gradation values of R, G, B from those of adjacent pixels exist in predetermined second ranges. When the conditions on the first and second ranges are satisfied, the pixel is decided to have the specified color. Thus, by including the condition of gradation differences relative to adjacent pixels, differences due to deterioration of the scanner, change in environmental conditions or stress conditions can be decreased.

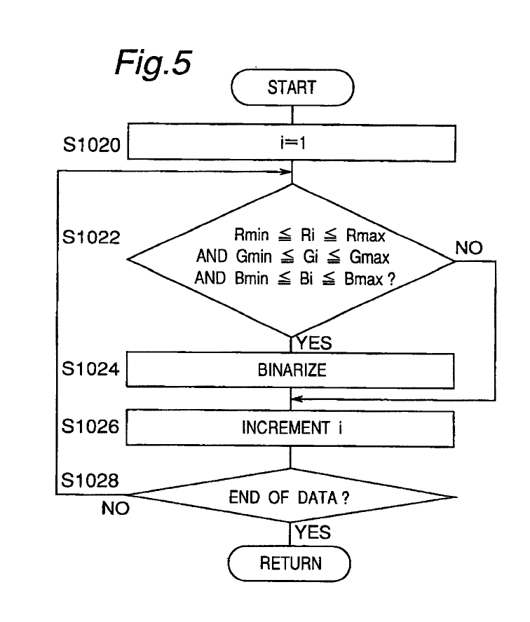

FIG. 4 shows a flowchart of the decision whether pixels in the input image data have the specified color (S12 in FIG. 3). First, color image data having color components of red (R), green (G) and blue (B) is received for the detection (S100). The image data are decided by the first decision means to be in first predetermined color ranges or not (S102), in order to detect the specified color. Practically, in a flowchart of the first decision means shown in FIG. 5, maximum values of Rmax, Gmax and B max and minimum values, Rmin, Gmin, and Bmin of R, G and B have been determined beforehand, and a variable, i, for representing a pixel is initialized to one (S1020). The variable, i, has a value of 1, 2, . . . , n. Next, it is decided whether input image data of i-th pixel satisfy following conditions of color range (S1022).

Rmin≦Ri≦Rmax,

Gmin≦Gi≦Gmax, (1)

and

Bmin≦Bi≦Bmax.

Only if these conditions are satisfied, the pixel is decided as a specified color candidate (S1024). A pixel decided as a specified color candidate is denoted as an on-pixel, while a pixel not decided as a specified color candidate is denoted as an off-pixel. Thus, binarization is performed. Next, i is incremented (S1026), and if the data processing have not been completed on all the pixels (NO at step S1028), the flow returns to step S1022 to repeat the above-mentioned processing.

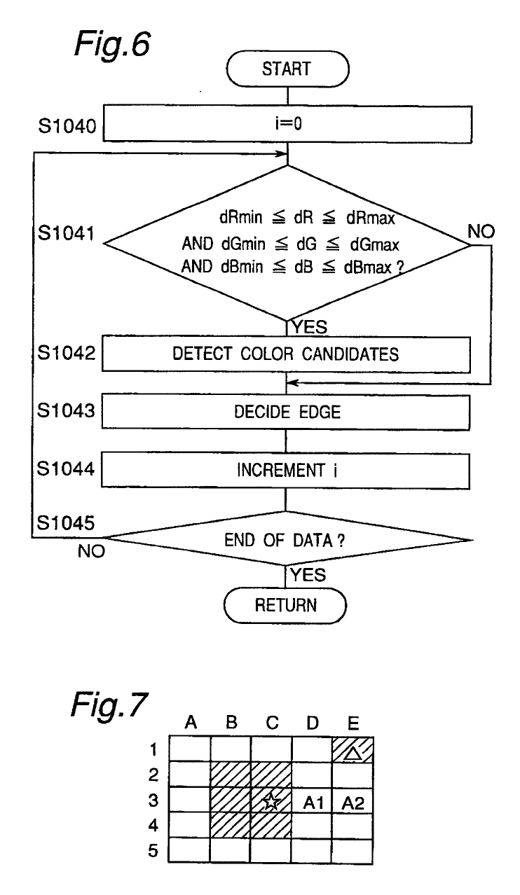

Returning to FIG. 4, input image is decided by a second decision means (S104). If the color decision is performed only by using the maxima and minima of R, G and B, as in the above-mentioned first decision means (S102), a color (noise) different clearly for the color to be detected is liable to be detected. Then, in order to remove the noise, the second decision means is used. For example, in order to decide whether the pixel has the color to be detected, gradation differences from R, G and B data of adjacent pixels are obtained, and the color ranges are defined on the gradation difference. Practically, in a flowchart of the second decision means shown in FIG. 6, maximum values of d R max, d G max and d B max and minimum values, dRmin, dGmin, and dBmin of differences dR, dG and dB of from P, G and B data of adjacent pixels have been determined beforehand. First, a variable, i, for representing a pixel is initialized to one (S1040). The variable, i, has a value of 1, 2, . . . , n. Next, it is decided whether the input image data of i-th pixel satisfy following conditions of color range (S1041).

dRmin≦dR≦dRmax,

dGmin≦dG≦dGmax, (2)

and

dBmin≦dB≦dBmax.

Only if these conditions are satisfied, the pixel is decided to have a specified color, and it is decided as a specified dolor candidate (S1042). The differences, dR, dG and dB, will be explained later. Further, as to the pixel, gradation differences of R, G and B data thereof from those of adjacent pixels existing in one direction are determined, and they are compared with predetermined threshold values in order to determine a position of edge in the direction (S1043). This edge detection is performed in top, bottom, right, left and oblique directions. Next, i is incremented (S1044), and if the data processing have not yet been completed on all the pixels (NO at step S1045), the flow returns to step S1042 to repeat the above-mentioned steps.

Finally, returning to FIG. 4, the decision results of the first and second decision means are subjected to AND operation for each pixel (S106). That is, the pixel on which both of the first and second decision means decide to have the detection color candidate is decided to have the detection color.

The second decision means is explained further with reference to FIG. 7. The pixels with hatching represent on-pixels. The adjacent pixels are 5*5 pixels around a target pixel. The maxima dR, dG and dB are gradation differences between the target pixel (designated with a star mark) and the adjacent pixels. If the differences dR, dG and dB between the maxima of R, G and G data of the adjacent pixels from R, G and B of the target pixel are in the above-mentioned ranges, the pixel is decided to be a detection color candidate. For example, if a pixel (designated with a triangular mark) has the largest R in the adjacent pixels and if the difference of the largest R from R of the target pixel exists in the above-mentioned range, the target pixel is decided as a detection color candidate. Data G and B of the other colors are also subjected to the decision similarly. Only when the pixel is decided as a detection color candidate on all the data of R, G and B, it is decided as a detection color candidate. Though, in this example, the maximum of each of R, G and B data of the adjacent pixels is used for the decision. However, for example, the maximum of a sum of the R, G and B data may be used for the decision.

An edge of a pattern can be discriminated correctly by deciding the differences of the color data between a pixel and adjacent pixels thereof in different directions relative to the pixel (S143 in FIG. 6). Therefore, when small elements in the specified pattern are detected in the input image, an edge thereof can be extracted correctly. Because only the edge of the small element can be extracted, when a shape of the small element is detected, it is not liable to be affected by line width or the like.

For example, in the example shown in FIG. 7, gradation differences relative to the target pixel (star mark) are determined based on the R, G and B data of adjacent pixels A1 and A2 distant by one and two pixels in right direction. Then, an edge in right direction can be discriminated correctly. By processing similarly in top, bottom, left and oblique directions, an edge can be discriminated correctly irrespective of the conditions of input image. Therefore, when only an edge is extracted, the position of an edge can be decided correctly by decision in various directions.

An advantage of this embodiment is that differences due to deterioration of the scanner, change in environmental conditions and change in stress conditions can be decreased by taking gradation differences from adjacent pixels into account. Another advantage is that because only edges of small elements can be extracted, the detection of a shape of the small element is not liable to be affected by line width or the like. Further, the position of an edge can be discriminated correctly.

Next, a second embodiment of the invention is explained. In the detection of a specified pattern, a specified pattern is detected in image data having a plurality of color data for each pixel received from an image input device such as the scanner 24. The detection of a specified pattern according to the second embodiment is the same as that according to the first embodiment explained above except the second decision means (S104 in FIG. 4). When an image is read with the scanner 24, the color of the read image varies with scan conditions. Further, the image data are also affected by deterioration of the scanner, change in environmental conditions, change in stress conditions or the like. Therefore, in order to detect a specified image, it is needed to widen the detection range of color. However, the widening of detection range is a factor which increases noises and detection errors. Then, in the second decision means in this embodiment, as will be explained below, in order to widen color detection range without increasing detection errors, ranges of results of linear operation such as (R−G), (G−B), (R−B), (R+G), (G+B) and (R+B) are taken into account besides the values of lightness of R, G and B.

In the flowchart shown in FIG. 4, it is decided by the second decision means whether the input image exists in detection ranges different from the above-mentioned relationships (1) (S104). If only the maximum and minimum values of R, G and B are taken into account, a color clearly different from the detection color (hereinafter referred to as noise) may be detected. Then, in order to remove noises, a different condition is used. The condition mentioned below is an example.

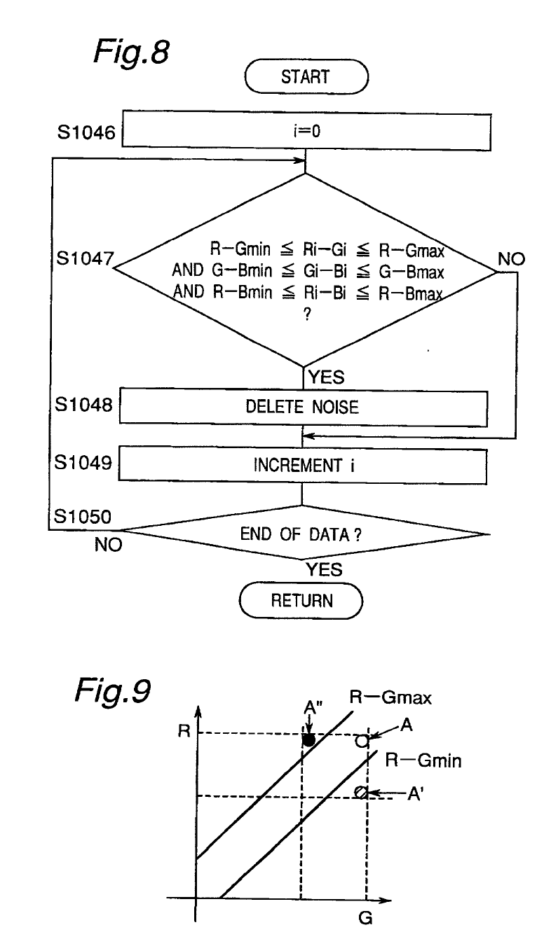

FIG. 8 is a flowchart of the second decision means (S104 in FIG. 4). First, a variable i is reset to one for initialization (1046), wherein i has a value of 1, 2, . . . , n. Next, as to the input image data of i-th pixel, it is decided whether R−G, G−B and R−B satisfy following conditions (S1047)

R−Rmin≦Ri−Gi≦R−Gmax,

G−Bmin≦Gi−Bi≦G−Bmax, (3)

and

R−Bmin≦Ri−Bi≦R−Bmax.

If these condition are not satisfied, the i-th pixel is deleted from the specified color candidates as noise (S1048). Next, i is incremented (S1049), and if the data processing have not yet been completed on all the pixels (NO at step S1050), the flow returns to step S1042 to repeat the above-mentioned steps.

Then, an AND operation of the results of the first and second decision means is performed for each pixel (S106 in FIG. 4). That is, a pixel decided as a detection color candidate both by the first and second decision means is decided to have the detection color.

The second decision means is explained further. In an example, when yellow is detected in the R and G space as a specified color, as shown in FIG. 9, the maxima and minima are set as follows: Rmax=255, Rmin=150, Gmax=255, and Gmin=150. In the case of yellow (A), the image data are as follows: R=255, G=255 and B=0. However, if only the conditions (1) are used, a color (A′) of R=255 and G−150 and another color (A″) of R=150 and G=255 are also detected as yellow. If the balance of R and G is changed, yellow moves towards red or green. Therefore, when the balance of R and G is changed largely, it is desirable to detect it as a different color. Therefore, by using different conditions (3), the difference between R and G of the target pixel is limited within a certain value. Thus, noises such as A′ and A″ can be removed.

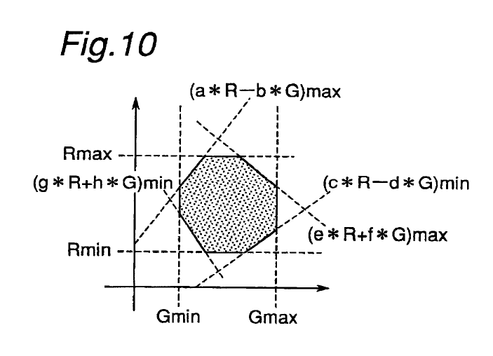

In a modified example shown in FIG. 10, it is possible to set conditions on the ranges in detail. Instead of the second conditions (3) on the simple differences of image data, data of linear operation such as a sum or difference with use of coefficients for each image data (or more generally, a function of R, G and B) may be used to limit the detection ranges. In FIG. 10, the reference characters, a, b, c, d, e, f, g and h, denote coefficients for linear operations, and a dot area in FIG. 10 represents the range for detection of specified color limited by linear operations of (a*R−b*G)max, (c*R−d*G)min, and the like. In FIG. 10, the conditions on the maxima and minima on the image data R, G themselves, that is, Rmax, Rmin, Gmax and Gmin. Though FIG. 10 shows only the R and G space, but similar conditions are set on the G and B space and on the R and B space.

An advantage of this embodiment is that a specified color in a specified pattern can be detected even when the input image data are affected by deterioration of the scanner, change in environmental conditions, change in stress conditions or the like. Another advantage of this embodiment is that errors in color detection can be decreased by narrowing the color detection ranges with use of different types of conditions.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An image processor comprising:
a first decision controller which decides whether input color data of a target pixel exist in first ranges;
a second decision controller which decides whether differences between color data of the target pixel and those of pixels adjacent thereto exist in second ranges different from the first ranges; and
a color decision controller which decides that the target pixel has a specified color when the first decision controller decides that the color data of the target pixel exist in the first ranges and the second decision controller decides that the differences exist in the second ranges.

2. The image processor according to claim 1, wherein said second decision controller determines a maximum value among differences of color data between the target pixel and the adjacent pixels thereof and decides whether the maximum value exists in the second ranges.

3. The image processor according to claim 1, further comprising an edge detector which calculates differences in a plurality of color component data of the color data between the target pixel and the adjacent pixels thereof in a direction and decides a position of an edge based on the differences.

4. The image processor according to claim 1, further comprising:
an extraction controller which extracts an element having a predetermined shape based on the decision by said color decision controller; and
a pattern detector which detects a specified pattern in the image data by discriminating whether the elements extracted by said extraction controller have a predetermined relationship between them.

5. A method of image processing comprising the steps of;
deciding whether input color data of a target pixel exist in first ranges;
deciding whether differences between color data of the target pixel and those of pixels adjacent thereto exist in second ranges different from the first ranges; and
deciding that the target pixel has a specified color when the color data of the target pixel is decided to exist in the first ranges and the differences are decided to exist in the second ranges.

6. The method according to claim 5, wherein a maximum value among differences of color data between the target pixel and the adjacent pixels thereof are obtained and it is decided whether the maximum value exists in the second ranges.

7. The method according to claim 5, further comprising the steps of:
extracting an element having a predetermined shape based on the decision that the target pixel has a specified color; and
detecting a specified pattern in the image data by discriminating whether the extracted elements have a predetermined relationship between them.

8. A recording medium to be executed by a computer storing a program comprising the steps of:
deciding whether input color data of a target pixel exist in first ranges;
deciding whether differences between color data of the target pixel and those of pixels adjacent thereto exist in second ranges different from the first ranges; and
deciding that the target pixel has a specified color when the color data of the target pixel is decided to exist in the first ranges and the differences are decided to exist in the second ranges.

9. The recording medium according to claim 8, wherein a maximum value among differences of color data between the target pixel and the adjacent pixels thereof are obtained and it is decided whether the maximum value exists in the second ranges.

10. The recording medium according to claim 8, the program further comprising the steps of: extracting an element having a predetermined shape based on the decision that the target pixel has a specified color; and
detecting a specified pattern in the image data by discriminating whether the extracted elements have a predetermined relationship between them.

11. An image processor comprising:
a first decision controller which decides whether input color data of a target pixel exist in first ranges;
a second decision controller which performs calculation on the input color data of the target pixel and decides whether results of the calculation exist in second ranges different from the first ranges; and
a color decision controller which decides that the target pixel has a specified color when the first decision controller decides that the color data of the target pixel exist in the first ranges and the second decision controller decides that the results exist in the second ranges.

12. The image processor according to claim 11, wherein the color data includes a plurality of color component data and said second decision controller calculates differences between the color component data of the target pixel and decides whether the differences exist in the second ranges.

13. The image processor according to claim 11, further comprising:
an extraction controller which extracts an element having a predetermined shape based on the decision by said decision controller; and
a pattern detector which detects a specified pattern in the image data by discriminating whether the elements extracted by said extraction controller have a predetermined relationship between them.

14. A method of image processing comprising the steps of:
deciding whether input color data of a target pixel exist in first ranges;
performing calculation on the input color data of the target pixel and decides whether results of the calculation exist in second ranges different from the first ranges; and
deciding that the target pixel has a specified color when the color data of the target pixel are decided to exist in the first ranges and the results are decided to exist in the second ranges.

15. The method according to claim 14, wherein the color data includes a plurality of color component data, differences between the color component data of the target pixel are obtained in the calculation on the input color data and it is decided whether the differences exist in the second ranges.

16. The method according to claim 14, further comprising the steps of:
extracting an element having a predetermined shape based on the decision that the target pixel has a specified color; and
detecting a specified pattern in the image data by discriminating whether the extracted elements have a predetermined relationship between them.

17. A recording medium to be executed by a computer storing a program comprising the steps of:
deciding whether input color data of a target pixel exist in first ranges;
performing calculation on the input color data of the target pixel and decides whether results of the calculation exist in second ranges different from the first ranges; and
deciding that the target pixel has a specified color when the color data of the target pixel are decided to exist in the first ranges and the results are decided to exist in the second ranges.

18. The method according to claim 17, wherein the color data includes a plurality of color component data, differences between the color component data of the target pixel are obtained in the calculation on the input color data and it is decided whether the differences exist in the second ranges.

19. The method according to claim 17, the program further comprising the steps of:
extracting an element having a predetermined shape based on the decision that the target pixel has a specified color; and
detecting a specified pattern in the image data by discriminating whether the extracted elements have a predetermined relationship between them.
